(19) United States
(12) Patent Application Publication
(10) Pub. No.: US 2023/0190417 A1
(43) Pub. Date: Jun. 22, 2023

(54) Dental implant platform and connection

(71) Applicant: feras Al rezk, visalia, CA (US)

(72) Inventor: feras Al rezk, visalia, CA (US)

(21) Appl. No.: 17/645,056

(22) Filed: Dec. 20, 2021

(51) Int. Cl. A61C 8/00

(52) U.S. Cl. CPC A61C 8/0018; A61C 8/0093

(57) ABSTRACT

This new dental implant Art is physiobiological driven designed to achieve the optimal healing and longevity of bone and gingiva architecture around the dental implant platform and connection. The new invention extends the internal connection planes of dental implant from bone level to soft tissue level vertically while keeping the external outline planes at mismatch with the external planes of the dental implants body that design to be placed in bone

The new invention would improve the current and prior Art and provide unlimited possibility.

### BACKGROUND

### Field of the Invention

The present invention is new dental implant platform and connection in relation to the transmucosal dental abutment for internal connection type of dental implant.

### Description of the Related Art

The current art is composed of internal connection type of dental implant apparatus that either tissue level platform with flared soft tissue portion that continuous with the external plane of the implant body, or bone level dental implant apparatus.

These two systems of the internal connection type of dental implants has advantages and disadvantages.

### SUMMARY

Certain embodiments of the present invention include, but are not limited to allow vertical and horizontal space (FIG. 4) for the soft tissue and gingiva adjacent to the transmucosal part of the dental implant, this New invention will increase the surface of abutment/dental connection toward soft tissue thickness.

This new invention will eliminate the disadvantages of current Art of internal connection dental implant for both tissue level and bone level.

This new invention will preserve the advantages of both types of internal connection bone level and tissue level.

This new art will provide flexibility in placement of the dental implant in the vertical dimension.

### BRIEF DESCRIPTION OF THE DRAWINGS

FIG. 1 frontal plane of one of the possibilities of dental implant/abutment drawing showing the new Art and the fundamental components.

FIG. 2 side to side comparison between the current Art (bone level) and the new Art.

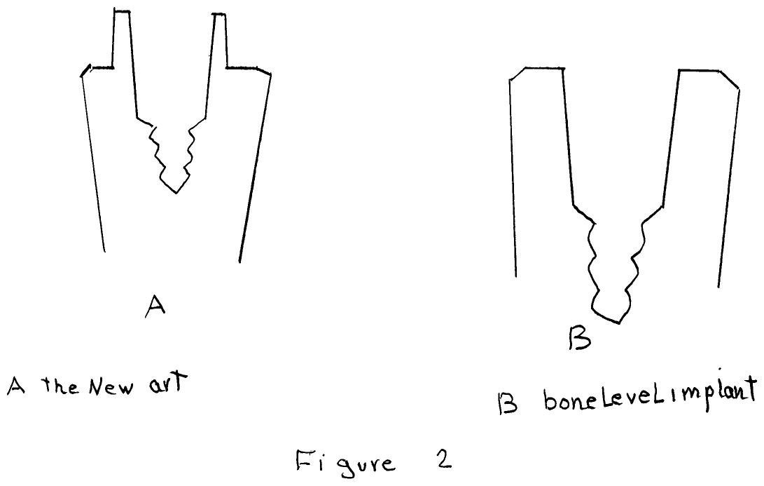

FIG. 3 side to side comparison between the current Art (tissue level) and the new Art.

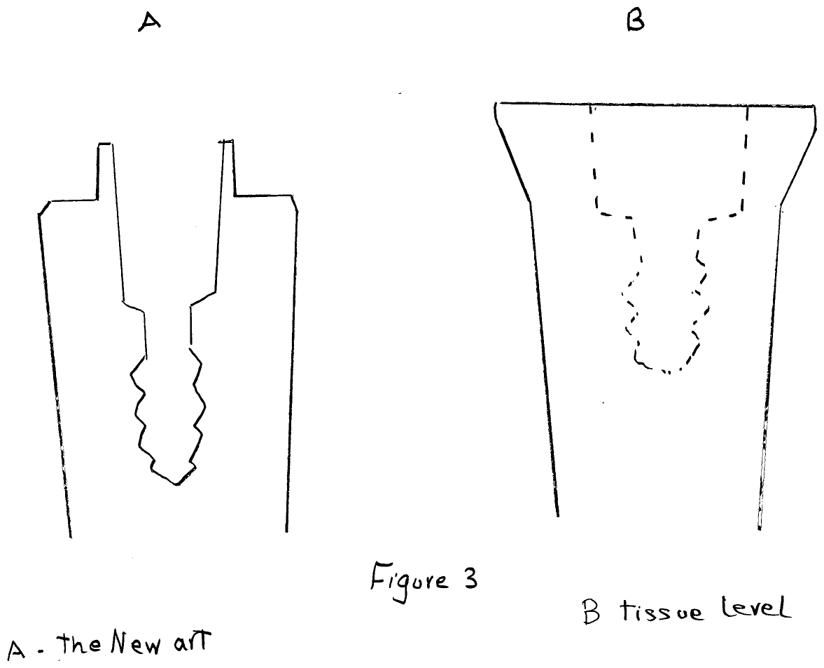

FIG. 4 the new Art as in magnified from FIG. 1.

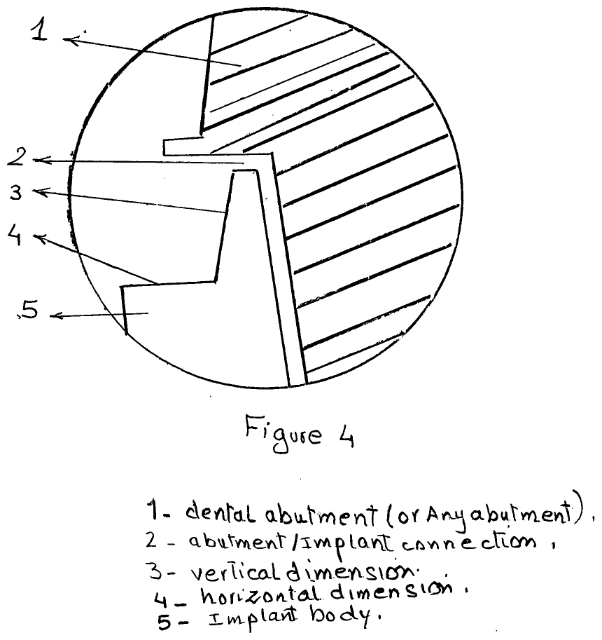

FIG. 5 coronal view of the new art.

FIG. 6 transverse view of one of the possibilities of the coronal outline of the new Art related to bone and transmucosal tissue.

FIG. 7 horizontal and vertical component may differ and vary in measurement.

### DETAILED DESCRIPTION

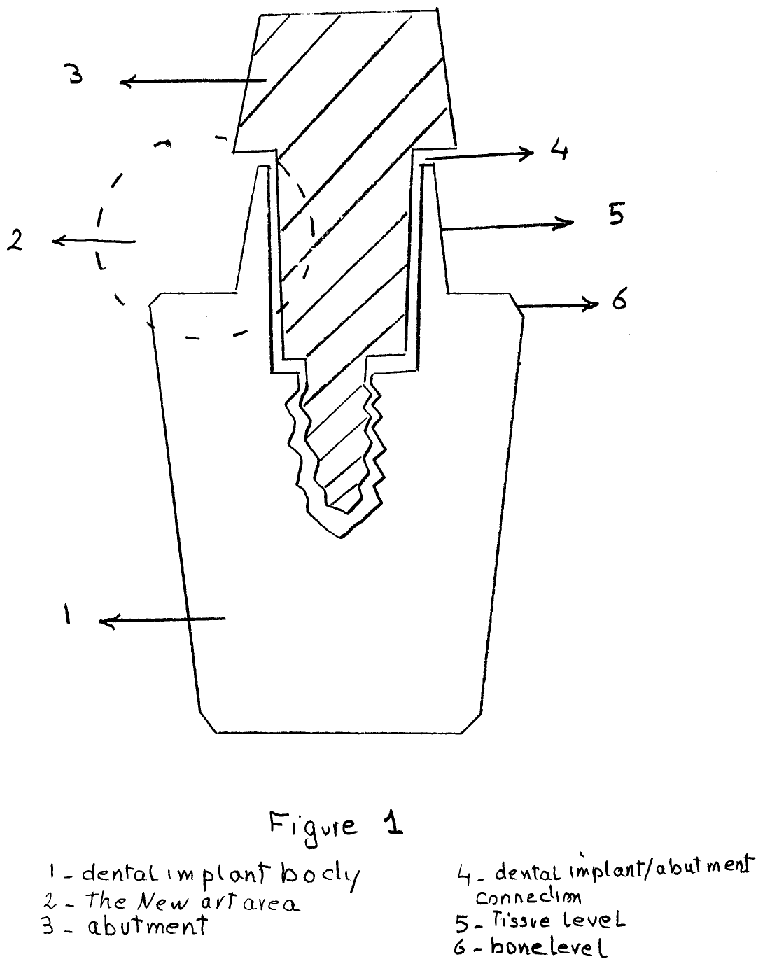

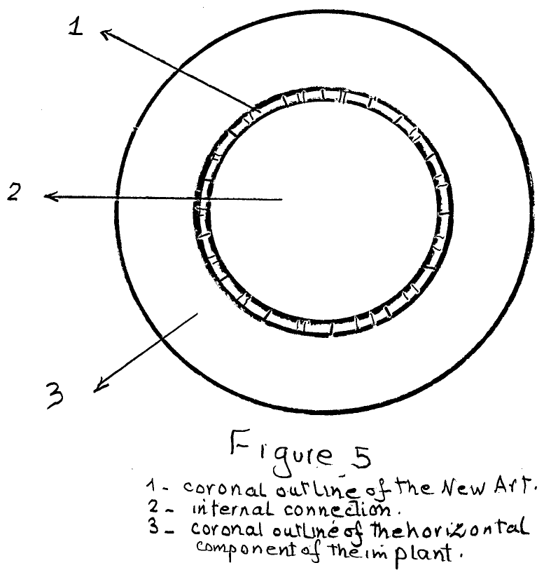

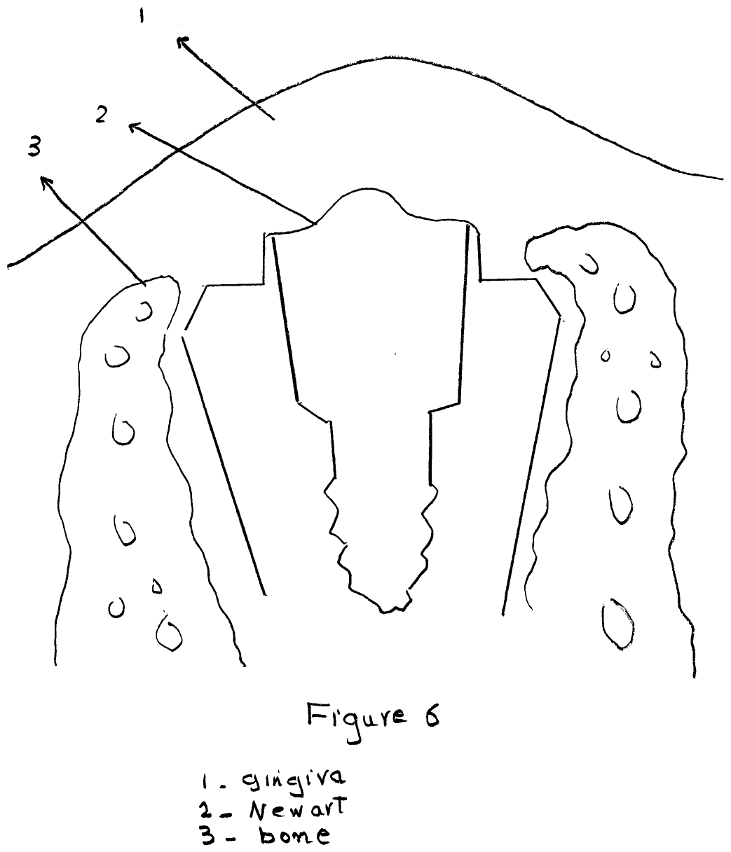

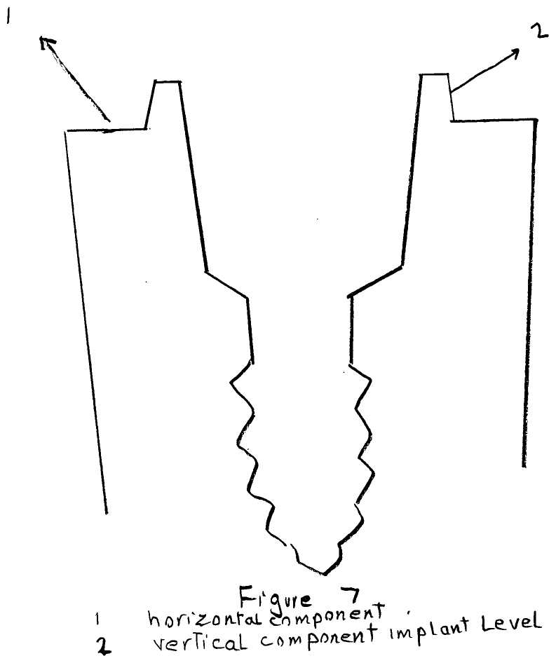

The new invention extends the internal connection planes of dental implant from bone level to soft tissue level vertically while keeping the outline planes at mismatch (FIG. 7) with the external planes of the dental implants body (FIG. 1), the coronal outline (FIG. 5) of the new Art could be design flat or preferably to be parallel to soft tissue architecture (FIG. 6) (the coronal outline could be but not limited to the shape of scalloped, beveled, or circular). the rough surface (design for bone level) could meet the polish surface (design for soft tissue) at any level vertically or horizontally along the new Art (FIG. 6). the mismatch allows vertical and horizontal space for the soft tissue physiological and biological thickness requirement around the dental implant platform while transfer the abutment dental connection away from the crestal bone level. The new Art will provide uninterrupted, undisturbed interaction with soft tissue during wound healing and beyond, this would provide soft tissue seal, preserve crestal bone, strengthen the abutment implant connection, provide prosthetic flexibility and improved emergence profile and many more desirable benefits.

The embodiments of the new Art may be differing in materials, function shapes design and other specifications (FIG. 7)

The embodiments of the new Art may be differing in materials, function shapes design and other specifications (FIG. 7)

1. The new Art will keep the advantages for internal connection bone level and tissue level dental implants and minimize the disadvantages of those of internal connection current Art.
